(19) United States
(12) Patent Application Publication
(10) Pub. No.: US 2011/0091188 A1
(43) Pub. Date: Apr. 21, 2011

(54) PLAYBACK APPARATUS AND CONTROL METHOD OF PLAYBACK APPARATUS

(75) Inventor: Masahiro TADA, Tachikawa-shi (JP)

(73) Assignee: KABUSHIKI KAISHA TOSHIBA, Tokyo (JP)

(21) Appl. No.: 12/909,713

(22) Filed: Oct. 21, 2010

(30) Foreign Application Priority Data
Oct. 21, 2009 (JP) 2009-242661

(51) Int. Cl. H04N 5/917

(52) U.S. Cl. 386/355; 386/E05.003

(57) ABSTRACT

According to one embodiment, a control method of a playback apparatus includes performing a first process when second video data is subjected to an image quality enhancement process, the first process includes writing first data of one frame of the decoded video data in an intermediate video surface region of a memory, causing a first processor to perform an image quality enhancement process for the first data in the intermediate video surface region, writing, in the first back buffer region of the memory, second data corresponding to the first data subjected to the image quality enhancement process, and outputting the second data, and performing a second process when the decoded video data is not subjected to the image quality enhancement process, the second process includes writing third data of one frame of the decoded video data in a second back buffer region of the memory, and outputting the third data.

### CROSS-REFERENCE TO RELATED APPLICATIONS

This application is based upon and claims the benefit of priority from Japanese Patent Application No. 2009-242661, filed Oct. 21, 2009; the entire contents of which are incorporated herein by reference.

### FIELD

Embodiments described herein relate generally to a playback apparatus for switching execution/non-execution of a image quality enhancement process and a control method for the playback apparatus.

### BACKGROUND

When video data is displayed by use of a personal computer, the video data is subjected to a image quality enhancement process.

The technique for switching a normal mode in which a video signal is transmitted to an LCD without using an exclusive image quality enhancement engine that performs a image quality enhancement process to a image quality enhancement mode using a image quality enhancement engine when it is detected that display of video data is set in a full-screen mode is disclosed in Jpn. Pat. Appin. KOKAI Publication No. 2006-30891.

In the technique described in the above document, a whole image displayed on the LCD is subjected to the image quality enhancement process.

The image quality enhancement process is performed by use of an exclusive image quality enhancement engine. Recently, the image quality enhancement process may be sometimes performed by means of a graphic processing unit (GPU) with an increase in the operating speed of the GPU.

The image quality enhancement process can be performed by means of a graphic processing unit (GPU) with an increase in the operating speed of the graphic processing unit (GPU). In cases where the image quality enhancement process is performed by means of the GPU and the process is not performed, the GPU may change the way of treating video data in a memory (VRAM). Therefore, in cases where the image quality enhancement process is performed by means of the GPU and the process is not performed, it is desired to develop a highly efficient video data treatment method.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing a notebook personal computer as a playback apparatus according to one embodiment.

FIG. 2 is an exemplary block diagram showing the system configuration of the personal computer shown in FIG. 1.

FIG. 3 is an exemplary view showing a playback control panel displayed on an LCD to perform an operation for switching upconvert/non-upconvert and the like.

FIG. 4 is an exemplary block diagram showing the configuration of a DVD application executed by a CPU.

FIG. 5 is an exemplary diagram showing the data flow and surface configuration of a video process at the execution time of a image quality enhancement process.

FIG. 6 is an exemplary diagram showing the data flow and surface configuration of a video process at the non-execution time of a image quality enhancement process.

FIG. 7 is an exemplary flowchart showing the procedure for illustrating a video surface switching control operation according to execution/non-execution of the image quality enhancement process.

FIG. 8 is an exemplary flowchart showing the procedure of a display process according to execution/non-execution of the image quality enhancement process.

### DETAILED DESCRIPTION

Various embodiments will be described hereinafter with reference to the accompanying drawings.

In general, according to one embodiment, a playback apparatus includes a first processor, a decoder, and a second processor. The first processor is configured to perform a image quality enhancement process. The decoder is configured to decode compression-coded video data. The second processor is configured to perform a first process when the decoded video data is subjected to the image quality enhancement process and to perform a second process when the decoded video data is not subjected to the image quality enhancement process, the first process comprising allocating an intermediate video surface region to a memory, writing first data of one frame of the decoded video data in the intermediate video surface region, causing the first processor to perform the image quality enhancement process for the first data in the intermediate video surface region, and allocating a first back buffer region to the memory, writing, in the first back buffer region, second data corresponding to the first data subjected to the image quality enhancement process, and outputting the second data in the first back buffer region, and the second process comprising allocating a second back buffer region to the memory, writing third data of one frame of the decoded video data, and outputting the third data in the second back buffer region.

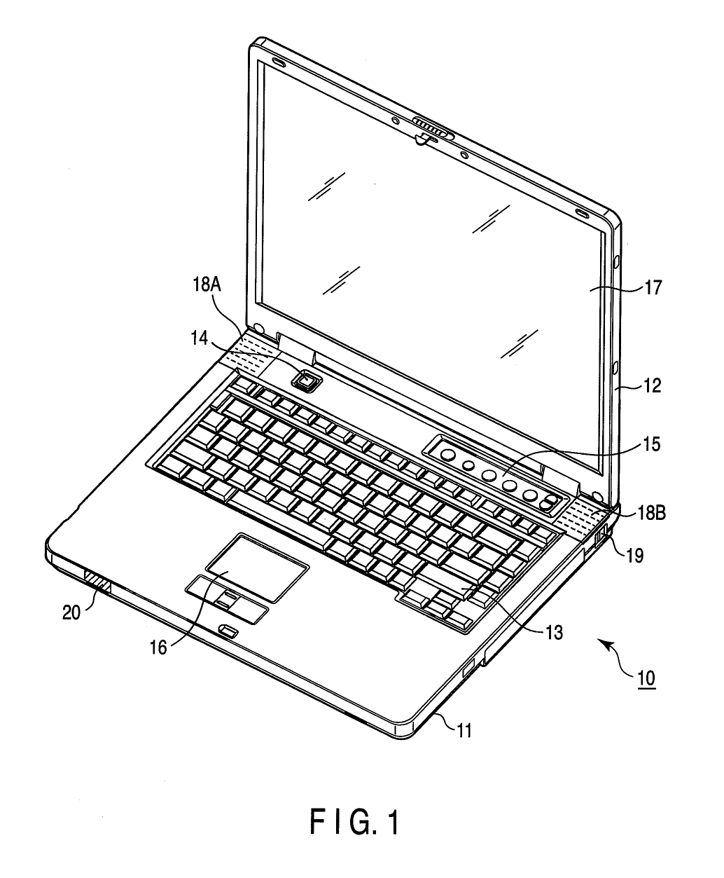

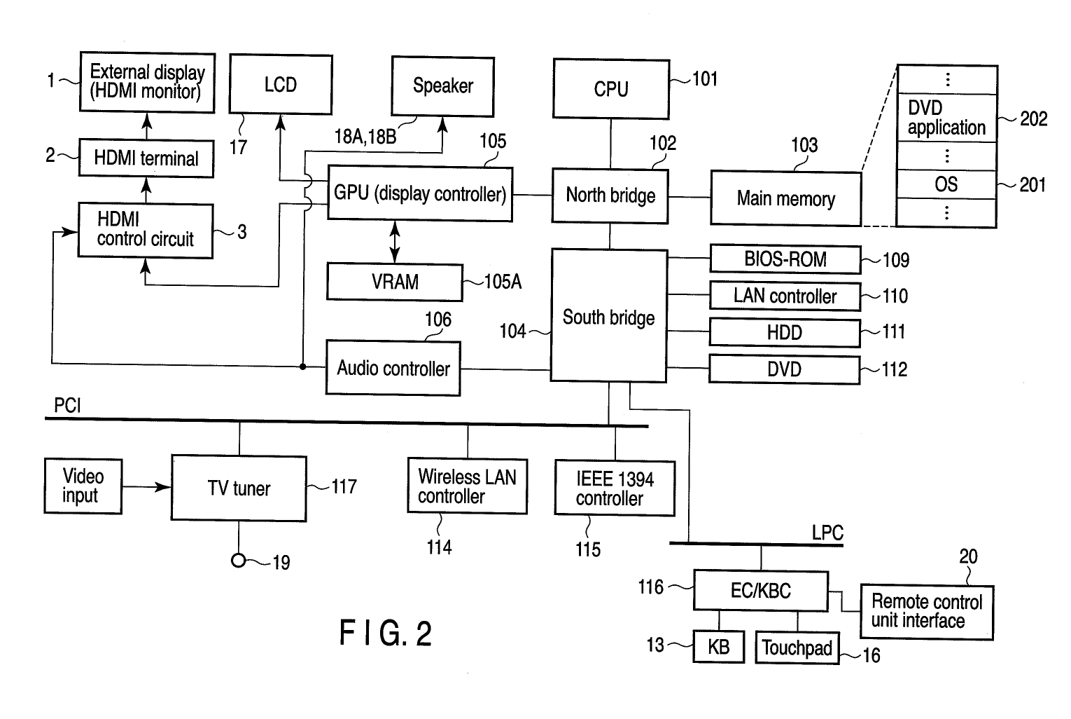

First, the configuration of a playback apparatus according to one embodiment is explained with reference to FIG. 1 and FIG. 2. The playback apparatus of this embodiment is configured by a notebook mobile personal computer 10 functioning as an information processing apparatus, for example.

The personal computer 10 can record and play back video content data (audio/visual content data) such as broadcast program data and video data input from an external device. That is, the personal computer 10 has a television (TV) function of permitting broadcast program data broadcast according to a television broadcast signal to be viewed and recorded. For example, the TV function is realized by use of a TV application program that is previously installed in the personal computer 10. Further, the TV function includes a function of recording video data input from an external AV device and a function of playing back recorded video data and recorded broadcast program data.

FIG. 1 is a perspective view showing a state in which the display unit of the computer 10 is opened. The computer 10 includes a computer main body 11 and a display unit 12. In the display unit 12, a display device configured by a thin film transistor liquid crystal display (TFT-LCD) 17 is incorporated. The number of pixels of the LCD is based on the full HD specification of 1920×1080.

The display unit 12 is mounted on the computer main body 11 to freely rotate between an open position in which the upper surface of the computer main body 11 is exposed and a closed position in which the upper surface of the computer main body 11 is covered. The computer main body 11 is a thin box-like casing and a keyboard 13, a power button 14 that turns on/off the power source of the computer 10, input operation panel 15, touchpad 16 and speakers 18A, 18B are arranged on the upper surface thereof.

The input operation panel 15 is an input device for inputting an event corresponding to a pressed button and includes a plurality of buttons used to respectively start a plurality of functions. The button group includes an operation button group to control a TV function (viewing, recording and playback of recorded broadcast program data/video data). Further, a remote control unit interface portion 20 used to make communication with a remote control unit that remotely controls the TV function of the computer 10 is provided on the front surface of the computer main body 11. The remote control unit interface portion 20 is configured by an infrared signal reception portion and the like.

An antenna terminal 19 for TV broadcasting is provided on the right-side surface of the computer main body 11, for example. Further, for example, an external display connection terminal conforming to the High-Definition Multimedia Interface (HDMI) standard is provided on the back surface of the computer main body 11. The external display connection terminal is used to output video data (moving image data) contained in video content data such as broadcast program data to an external display.

Next, the system configuration of the computer 10 is explained with reference to FIG. 2.

As shown in FIG. 2, the computer 10 includes a CPU 101, north bridge 102, main memory 103, south bridge 104, graphics processing unit (GPU) 105, video memory (VRAM) 105A, audio controller 106, BIOS-ROM 109, LAN controller 110, hard disk drive (HDD) 111, DVD drive 112, wireless LAN controller 114, IEEE 1394 controller 115, embedded controller/keyboard controller IC (EC/KBC) 116, TV tuner 117 and the like.

The CPU 101 is a processor for controlling the operation of the computer 10 and execute various application programs such as an operating system (OS) 201 and DVD application program 202 loaded from the had disk drive (HDD) 111 to the main memory 103. The DVD application program 202 is software to play back a DVD loaded on the DVD drive 112. Further, the CPU 101 executes a basic input output system (BIOS) stored in the BIOS-ROM 109. The BIOS is a hardware control program.

The north bridge 102 is a bridge device that connects the local bus of the CPU 101 to the south bridge 104. In the north bridge 102, a memory controller that performs an access control operation with respect to the main memory 103 is also contained. Further, the north bridge 102 has a function of making communication with the GPU 105 via a serial bus conforming to the PCI EXPRESS standard.

The GPU 105 is a display controller that controls the LCD 17 used as a display monitor of the computer 10. The GPU 105 uses the VRAM 105A as a work memory. A display signal generated by the GPU 105 is supplied to the LCD 17. Further, the GPU 105 can transmit a digital video signal to an external display device 1 via an HDMI control circuit 3 and HDMI terminal 2. The GPU 105 includes a plurality of operation processors and can perform a pixel shader process by use of at least a portion of the plurality of operation processors at the same time as generation of a display signal. Further, the GPU 105 can perform a programmed pixel shader process. For example, the image quality enhancement process of video data is performed by performing the pixel shader process.

The HDMI terminal 2 is the external device connection terminal described above. The HDMI terminal 2 can transmit a non-compressed digital video signal and digital audio signal to the external display device 1 such as a television via one cable. The HDMI control circuit 3 is an interface that transmits a digital video signal to the external display device 1 called an HDMI monitor via the HDMI terminal 2.

The south bridge 104 controls respective devices on a low pin count (LPC) bus and respective devices on a peripheral component interconnect (PCI) bus. Further, the south bridge 104 contains an integrated drive electronics (IDE) controller that controls the hard disk drive (HDD) 111 and DVD drive 112. In addition, the south bridge 104 also has a function of making communication with the audio controller 106.

The audio controller 106 is an audio source device and outputs audio data to be played back to the speakers 18A, 18B or HDMI control circuit 3.

The wireless LAN controller 114 is a wireless communication device that makes wireless communication conforming to the IEEE 802.11 standard, for example. The IEEE 1394 controller 115 makes communication with an external device via a serial bus of conforming to the IEEE 1394 standard.

The embedded controller/keyboard controller IC (EC/KBC) 116 is a single-chip microcomputer in which an embedded controller for power management and a keyboard controller for controlling the keyboard (KB) 13 and touchpad 16 are integrated. The embedded controller/keyboard controller IC (EC/KBC) 116 has a function of turning on/off the power source of the computer 10 in response to the operation of the power button 14 by the user. Further, the embedded controller/keyboard controller IC (EC/KBC) 116 has a function of making communication with the remote control unit interface portion 20.

The TV tuner 117 is a reception device that receives broadcast program data broadcast according to a television (TV) broadcast signal and is connected to the antenna terminal 19. For example, the TV tuner 117 is realized as a digital TV tuner capable of receiving digital broadcast program data such as digital terrestrial TV broadcast data. Further, the TV tuner 117 also has a function of capturing video data input from an external device.

The DVD application program 202 has a function of switching execution or non-execution of a image quality enhancement process such as a high-quality up-scaling, sharpness or color correction process with respect to a moving image displayed on the LCD 17. The image quality enhancement process is performed by means of the GPU 105. For example, the high-quality up-scaling process is performed by a bi-cubic method (3-dimensional convolution interpolation).

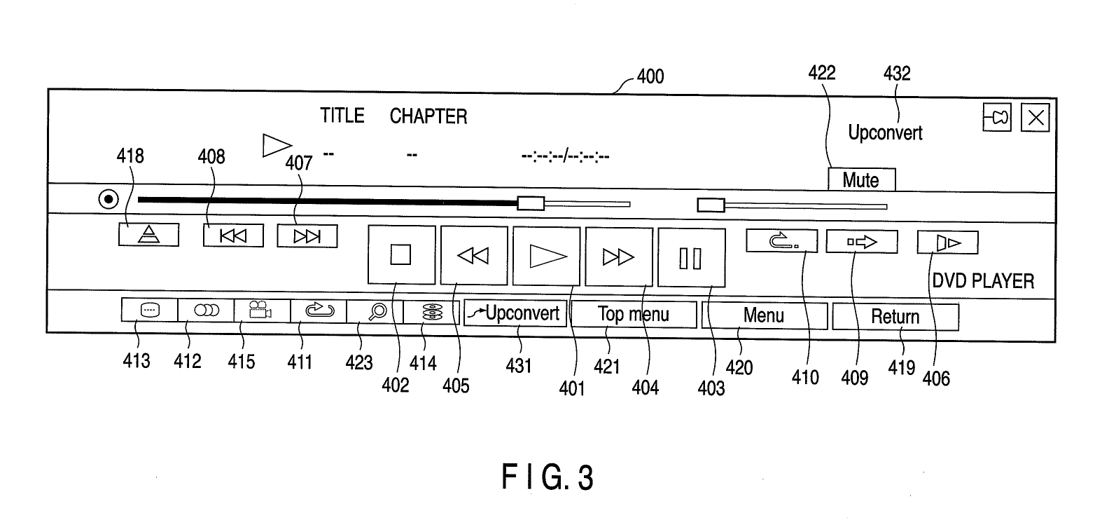

A playback control panel 400 displayed on the LCD 17 to permit the user to perform the operation of switching execution/non-execution of the image quality enhancement process and the like is shown in FIG. 3. The playback control panel 400 includes a play button 401 to play back a disk, a stop button 402 to stop playback, a pause button 403 to temporarily stop playback, a fast forward button 404 for fast-forwarding playback, a fast rewind button 405 for fast-rewinding playback, a forward slow playback button 406 for forward slow playback, a next-chapter button 407 for playback from the head of a next chapter, and a previous chapter button 408 for playback from the head of a previous chapter. The panel 400 further includes a one-touch replay button 409 for playback from the time approximately ten seconds before the present playback position, a one-touch skip button 410 for playback from the time approximately 30 seconds after the present playback position, a repeat button 411 for repeat playback and release of a chapter and title, a language switching button 412 for switching of playback languages, a subtitle switching button 413 for switching of subtitle languages, a drive/folder specification button 414 for specifying a drive/folder, and an angle switching button 415 for switching an angle. Additionally, the panel 400 includes an extraction button 418 for extracting a disk from the drive, a return button 419 for returning to the original position, a menu button 420 for displaying menus, a top menu button 421 for displaying a top menu, a silencer button 422 for temporarily silencing the volume of voice, and a chapter•title search button 423 for chapter searching or title searching. Further, the playback control panel includes an upconvert switching button 431 and upconvert state display region 432.

If the user moves the button onto the upconvert switching button 431 and presses the left button, the operation of switching execution/non-execution of the image quality enhancement process is performed. A letter of “upconvert” is displayed on the upconvert state display region 432 at the execution time of the image quality enhancement process. A letter of “upconvert” is not displayed on the upconvert state display region 432 at the non-execution time of the image quality enhancement process.

Next, the data structure specified in the DVD video system and management information thereof are explained.

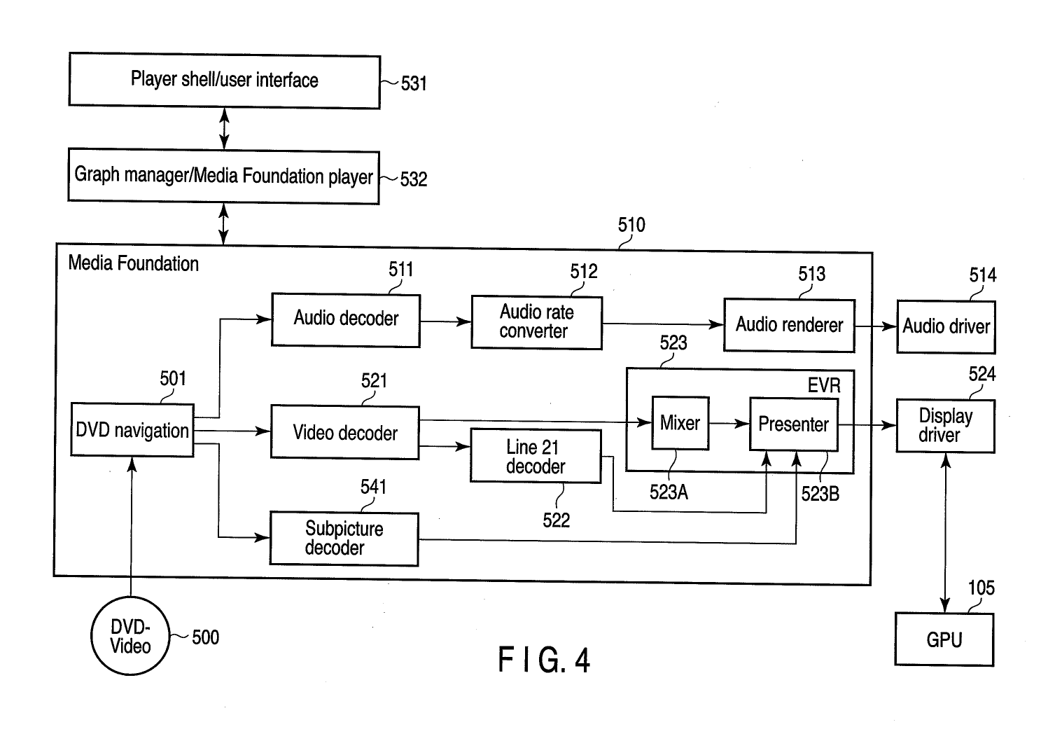

The configuration of the DVD application program 202 executed by the CPU 101 of the present apparatus to perform a playback operation is shown in FIG. 4. The player software utilizes the technique called Media Foundation executed under the Windows (registered trademark) environment that is an operating system of Microsoft Corporation to play back content. Media Foundation is a multimedia platform of Windows. Topology representing the flow of data in the pipeline which consists of three types of pipeline components including Media Source, Transform and Media Sink is generated. Media Source is a component that mainly deals with input data and generates media data, Transform is a component such as a decoder that lies in an intermediate position to process media data and Media Sink is a component such as a renderer that outputs media data.

DVD data played back by the DVD drive 112 is transmitted to a navigation 501. The navigation 501 separates a video pack (V_PCK), subpicture pack (SP_PCK) and audio pack (A_PCK) from the DVD data. The navigation 501 supplies the audio pack (A_PCK) to an audio decoder 511. Further, the navigation 501 supplies the video pack (V_PCK) and subpicture pack (SP_PCK) to a subpicture decoder 541.

The audio decoder 511 expands compression-coded voice information to convert the same to non-compressed audio data and supplies audio data to an audio rate converter 512. The audio rate converter 512 converts the rate of audio data to an adequate sampling rate and supplies the same to an audio renderer 513. The audio renderer 513 synthesizes the received audio data with audio data generated from other software or the like operated on the computer and supplies the result to an audio driver 514. The audio driver 514 controls the audio controller 106 to output audio from the speakers 18A, 18B.

In the video decoder 521, if data of a line 21 is contained, data of the line 21 is supplied to a line 21 decoder 522. The video decoder 521 expands the video pack (V_PCK) and the subpicture decoder 541 expands the subpicture pack (SP_PCK). The expanded video data is supplied to an expansion video renderer 523. A mixer 523A in the expansion video renderer 523 supplies video data received from the video decoder 521 to a presenter 523B.

The presenter 523B subjects video data (expanded video pack) to the image quality enhancement process, performs a process of synthesizing a subpicture (expanded subpicture pack) with a closed caption or performs a process of rendering video data. If the image quality enhancement process is performed, the presenter 523B performs an image quality enhancement process by use of the GPU 105.

Video data output from the presenter 523B is supplied to a display driver 524. The display driver 524 controls the GPU 105 and displays an image on the LCD 17.

A player shell/user interface 531 performs a process relating to display of the playback control panel 400. Further, the player shell/user interface 531 issues a command corresponding to a button operated by the user to a Media Foundation 510 via a graph manager/Media Foundation player 532. The Media Foundation 510 controls a topology configured by the navigation 501, audio decoder 511 and video decoder 521 according to the received command. When the user presses the upconvert switching button 431 to switch the image quality enhancement process, an instruction is transmitted from the player shell/user interface 531 to the graph manager/Media Foundation player 532 and then the graph manager/Media Foundation player 532 transmits an on/off state of the image quality enhancement process to the presenter 532B.

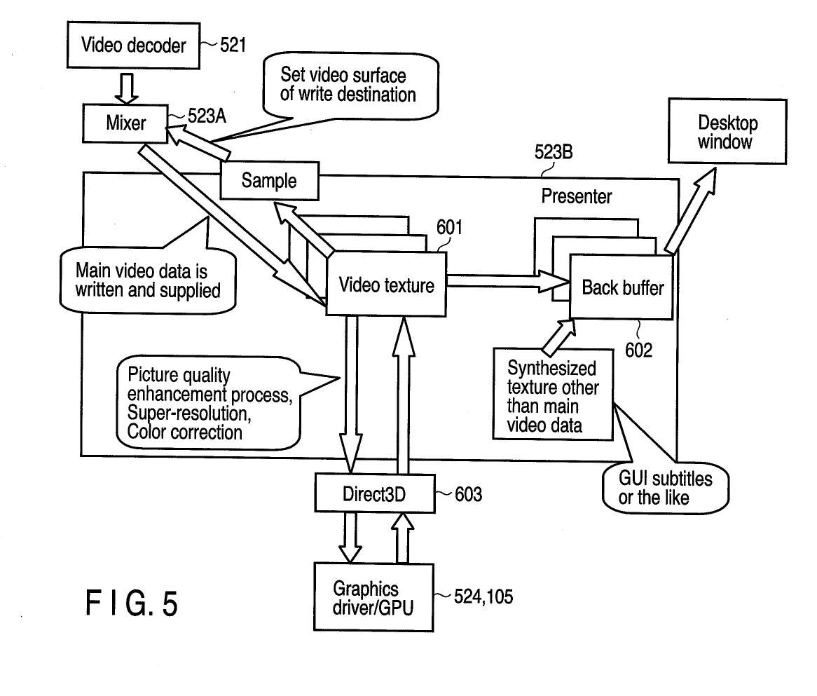

FIG. 5 shows the data flow and surface configuration of a video process at the execution time of the image quality enhancement process.

Communication of video data between the video decoder 521 and the mixer 523A, presenter 523B is performed via an object called a sample.

Compression-coded video data is input to the video decoder 521, a decoding process is performed in the video decoder 521 and then non-compressed video data is input to the mixer 523A of the EVR 523. The EVR 523 stably allocates a video texture 601 having a video surface that stores video data used by the presenter 523B to perform a image quality enhancement process such as high-quality up-scaling, sharpness or color correction in the VRAM 105A. The mixer 523A sets the memory area (video surface) allocated by the presenter 523B to a sample and writes video data of one frame to the video surface in the VRAM 105A thus allocated.

Then, the presenter 523B causes the GPU 105 to perform the image quality enhancement process by using the pixel shader of Direct3D 603 or the like with respect to the video surface of the video texture 601. Direct3D 603 is an API that draws 3D graphics. The API is a part of an API provided by DirectX of Microsoft Corporation. The pixel shader is a program executed by the GPU 105.

Video data subjected to the image quality enhancement process is written into a back buffer 602 of a Direct3D 603 device created (allocated) in the VRAM 105A by means of Direct3D 603. In the back buffer 602, data to be displayed in the window displayed on the display screen of the LCD 17 is stored. Further, the back buffer region is allocated at the initialization time of Direct3D 603 after generation of the presenter.

The presenter 523B synthesizes video data written into the back buffer region 602 with other video surfaces such as subtitles and closed caption at adequate timing at which the video surface of the video texture 601 is displayed. Subsequently, the presenter 523B instructs Direct3D 603 to display data in the back buffer 602 and, as a result, video data is practically displayed on the desktop.

The video decoder 521, the mixer 523A, the presenter 523B and Direct3D 603 are application components executed by the CPU 101.

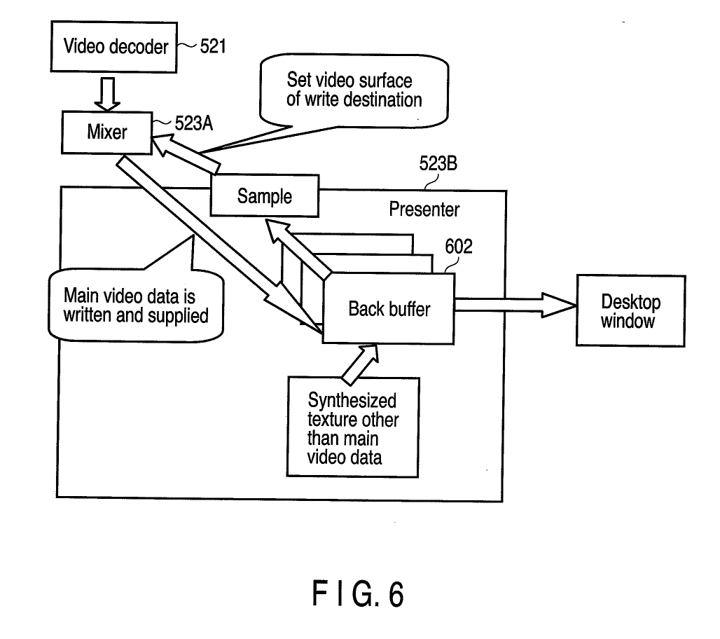

FIG. 6 shows the data flow and surface configuration of a video process at the non-execution time of the image quality enhancement process.

At the normal playback time, it is desirable to reduce the number of copy operations between video surfaces to the least possible number for enhancement of the video display performance and power saving. Therefore, the mixer 523A is designed to reduce the communication amount of video data by directly writing non-compressed video data into the back buffer 602 of the Direct3D device allocated by Direct3D 603.

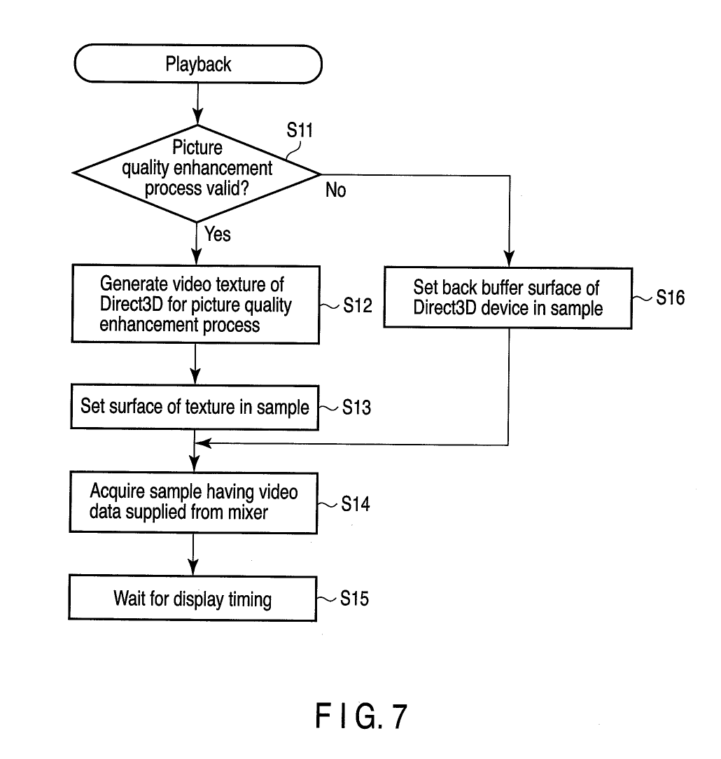

FIG. 7 is a flowchart showing the procedure for illustrating a video surface switching control operation according to execution/non-execution of the image quality enhancement process.

When the user makes the image quality enhancement function valid (Yes in block S11), the presenter 523B allocates a video texture (intermediate video surface) 601 for the image quality enhancement process in the VRAM 105A (block S12). Then, the presenter 523B sets a surface of the video texture 601 as a sample to acquire video data (block S13).

If the image quality enhancement function is made invalid (No in block S11), the presenter 523B directly sets a video surface in the back buffer 602 of the Direct3D device for window display previously allocated by Direct3D 603 to the sample (block S16).

Subsequently, the presenter 523B acquires a sample containing video data from the mixer 523A (block S14). Since time stamps to be displayed are set in the sample, they are held in the presenter 523B until display time is reached (block S15).

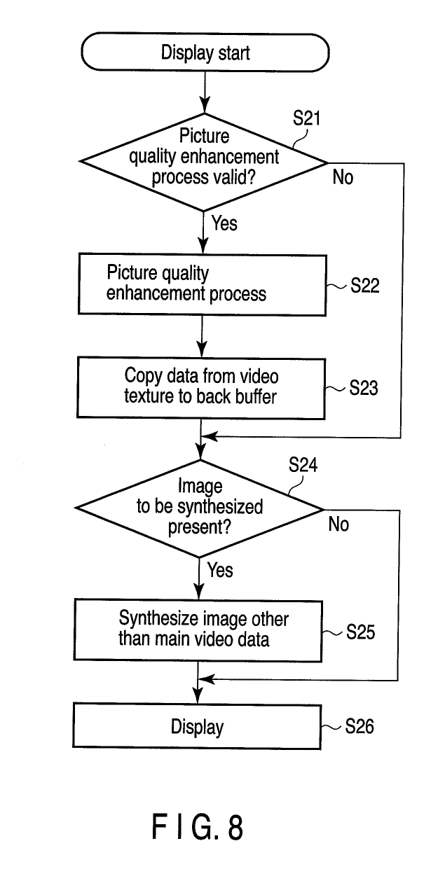

If the display time has elapsed, a process for display is started. The procedure of a display process according to execution/non-execution of the image quality enhancement process is explained with reference to a flowchart of FIG. 8.

When the image quality enhancement process is made valid (Yes in block S21), the presenter 523B performs the image quality enhancement process for the surface of the video texture 601 by use of the pixel shader of the GPU 105 (block S22). Video data subjected to the image quality enhancement process is set back from the GPU 105 to the video surface of the video texture 601 in the VRAM 105A. Video data subjected to the image quality enhancement process is written from the video surface of the video texture 601 to the back buffer 602 previously allocated in the VRAM 105A by means of Direct3D 603 (block S23). Whether or not image data items to be synthesized such as subtitles and closed captions are present is determined (block S24). If the process of displaying subtitles, closed captions, GUI and the like is not set, the synthesizing process becomes unnecessary.

If image data to be synthesized is present (Yes in block S24), the presenter 523B synthesizes video data in the back buffer 602 with data other than main video data (block S25). After the synthesizing process or if image data to be synthesized is not present (No in block S24), a display instruction is issued (block S26).

If the image quality enhancement process is made invalid (No in block S21), whether or not image data items to be synthesized such as subtitles and closed captions are present is determined (block S24) since video data is already stored in the back buffer 602. If image data to be synthesized is present (Yes in block S24), the presenter 523B synthesizes video data in the back buffer 602 with data other than main video data (block S25). After the synthesizing process or if image data to be synthesized is not present (No in block S24), a display instruction is issued (block S26).

In a video application including switching means for valid/invalid of the image quality enhancement process, it becomes possible to reduce the number of useless video data transfer operations by changing the surface configuration of the video renderer according to valid/invalid. As a result, video data in the VRAM 105A can be efficiently treated in a case where the image quality enhancement process is performed by means of the GPU 105 and in a case where the image quality enhancement process is not performed. For example, when the image quality enhancement process is not performed, the number of copy operations between the surfaces of image data can be reduced.

It is possible to permit the GPU 105 to perform a process for supporting the process of decoding compression-coded video data.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A playback apparatus comprising:
a first processor configured to perform an image quality enhancement process;
a decoder configured to decode compression-coded video data; and
a second processor configured to perform a first process if the decoded video data is subjected to the image quality enhancement process, and to perform a second process when the decoded video data is not subjected to the image quality enhancement process,
wherein the first process comprises
allocating an intermediate video surface region to a memory,
writing first data of one frame of the decoded video data in the intermediate video surface region,
causing the first processor to perform the image quality enhancement process for the first data in the intermediate video surface region,
allocating a first back buffer region to the memory,
writing second data in the first back buffer region, the second data corresponding to the first data subjected to the image quality enhancement process, and
outputting the second data in the first back buffer region, and
wherein the second process comprises
allocating a second back buffer region to the memory,
writing third data of one frame of the decoded video data, and
outputting the third data in the second back buffer region.

2. The playback apparatus of claim 1, further comprising:
a generation module configured to generate image data, and
a synthesizing module configured to synthesize the image data and the second data in the first back buffer region, or to synthesize the image data and the third data in the second back buffer region.

3. The playback apparatus of claim 1, wherein the first and second back buffer regions are configured to store data to be displayed in a window on a desktop displayed on a display screen of a display.

4. The playback apparatus of claim 1, wherein the first processor is configured to perform a pixel shader process in the image quality enhancement process.

5. The playback apparatus of claim 1, wherein the image quality enhancement process comprises at least one of up-scaling, sharpness and color correction processes.

6. A control method of a playback apparatus comprising:
decoding compression-coded video data;
performing a first process if the decoded video data is subjected to an image quality enhancement process,
wherein the first process comprises
allocating an intermediate video surface region to a memory used as a work memory of a first processor that performs the image quality enhancement process,
writing first data of one frame of the decoded video data in the intermediate video surface region,
causing the first processor to perform the image quality enhancement process for the first data in the intermediate video surface region,
allocating a first back buffer region to the memory,
writing second data in the first back buffer region, the second data corresponding to the first data subjected to the image quality enhancement process, and
outputting the second data in the first back buffer region; and
performing a second process if the decoded video data is not subjected to the image quality enhancement process,
wherein the second process comprises
allocating a second back buffer region to the memory,
writing third data of one frame of the decoded video data in the second back buffer region, and
outputting the third data in the second back buffer region.

7. The control method of the playback apparatus of claim 6, further comprising:
generating image data;
synthesizing the image data and the second data in the first back buffer region; and
synthesizing the image data and the third data in the second back buffer region.

8. The control method of the playback apparatus of claim 6, wherein the first and second back buffer regions are configured to store data to be displayed on a window in a desktop displayed on a display screen of a display.

9. The control method of the playback apparatus of claim 6, wherein the first processor is configured to perform a pixel shader process in the image quality enhancement process.

10. The control method of the playback apparatus of claim 6, wherein the image quality enhancement process comprises at least one of up-scaling, sharpness and color correction processes.
